(19) United States
(12) Patent Application Publication
(10) Pub. No.: US 2014/0117195 A1
(43) Pub. Date: May 1, 2014

(54) LIFT DEVICE

(71) Applicant: SYNCMOLD ENTERPRISE CORP., New Taipei City (TW)

(72) Inventors: Hung-Yu LIN, New Taipei City (TW); Wei-Yi HUANG, New Taipei City (TW)

(73) Assignee: SYNCMOLD ENTERPRISE CORP., New Taipei City (TW)

(21) Appl. No.: 14/054,181

(22) Filed: Oct. 15, 2013

(30) Foreign Application Priority Data
Oct. 25, 2012 (TW) 101220569

(51) Int. Cl. A47B 23/04; F16M 11/12

(52) U.S. Cl. CPC A47B 23/043; F16M 11/12
USPC 248/474

(57) ABSTRACT

A lift device includes a main body unit including a first board and two racks and a lifting unit. The two racks are separately and parallely configured on the first board in a first direction. The lifting unit includes a lifting board disposed on and parallel to the first board, and being slidable with respect to the first board in the first direction; and two abutting members disposed on the lifting board between the two blocks and each having an abutting block and a first elastic member, wherein the abutting block is slidable with respect to the lifting board in a second direction perpendicular to the first direction, and the first elastic member is disposed on the lifting board to abut against one end of the abutting block for enabling the other end of the abutting block to abut against the protruding portions.

### BACKGROUND OF THE INVENTION

1. Field of the Invention

The present invention relates to a supporting device, and more particularly, to a lift device for a display.

2. Description of Related Art

Laptops, notebooks and tablets are all portable. In particular, a tablet is known for being flat and having no physical keyboard, a kind of mobile computer, usually having a touchscreen or pen-enabled interface for users to process real-time information online with greater convenience and efficiency, so as to be a mainstream trendy product especially among the young generation.

However, a tablet has a flat shape for portability without any accompanying supporting structure to prop up in use, such that it is either held by users' own hands, or placed on a desktop or users' laps, which adversely hinders and restrains users' viewing angles. Therefore, users have to hunch their bodies forward and even bend their heads, resulting in pains over a long period time of using the tablet.

Therefore, supporting devices applicable for tablets have been developed to address the above problems. As illustrated in FIG. 1, the supporting device includes a base 10, a support 11, a lock member 12 and a securing frame 13 for holding a tablet in place. In using the supporting device, the tablet first needs to be fastened onto the securing frame 13, and after the adjustment of an appropriate and desired height of the tablet, the lock member 12 is used to lock and fasten the securing frame 13 onto the support 11. Inevitably, the adjustment of height of the supporting device requires users' hand maneuver of locking and unlocking the lock member at the rear of the tablet. It not only takes time but also inconveniences users as it is cumbersome to operate. Therefore, there exists a need for a novel supporting device for use with tablets.

### SUMMARY OF THE INVENTION

The invention provides a lift device, comprising a main body unit and a lifting unit.

The main body unit includes a first board; and two racks separately and parallelly configured on the first board in a first direction, wherein one of the two racks has a first side and the other of the two racks has a second side opposing to the first side, and wherein a plurality of protruding portions are disposed on each of the first side and the second side of the two racks.

The lifting unit includes a lifting board disposed on and parallel to the first board, and being slidable with respect to the first board in the first direction; and two abutting members disposed on the lifting board between the two blocks and each having an abutting block and a first elastic member, wherein the abutting block is slidable with respect to the lifting board in a second direction perpendicular to the first direction, and the second elastic member is disposed on the lifting board to abut against one end of the abutting block for enabling the other end of the abutting block to abut against the protruding portions under a normal condition.

Accordingly, the lift device of the invention is characterized by using racks and elastic members which can be easily manipulated by hands. Moreover, rotating and lifting angles of the lift device further are easily adjusted so as to increases practicality of the lift device. In addition, the compact structure of the lift device facilitates convenient portability and storage.

### BRIEF DESCRIPTION OF THE DRAWINGS

The present invention can be more fully understood by reading the following detailed description of the preferred embodiments, with reference made to the accompanying drawings, wherein:

FIG. 1A is a three-dimensional view of a conventional supporting device for a tablet computer;

FIGS. 2A to 2C are schematic views showing the lift device, in which FIGS. 2A and 2C are 3D views and FIG. 2B is a front view; FIGS. 2A and 2B illustrate the lifting mode of the lift device and FIG. 2C depicts the rotating mode of the lift device according to the present invention;

FIG. 3A illustrates a front view of the lift device with a display rack holder according to the present invention; and

FIG. 4A to 4C are side views illustrating different lifting angles of the lift device according to the present invention.

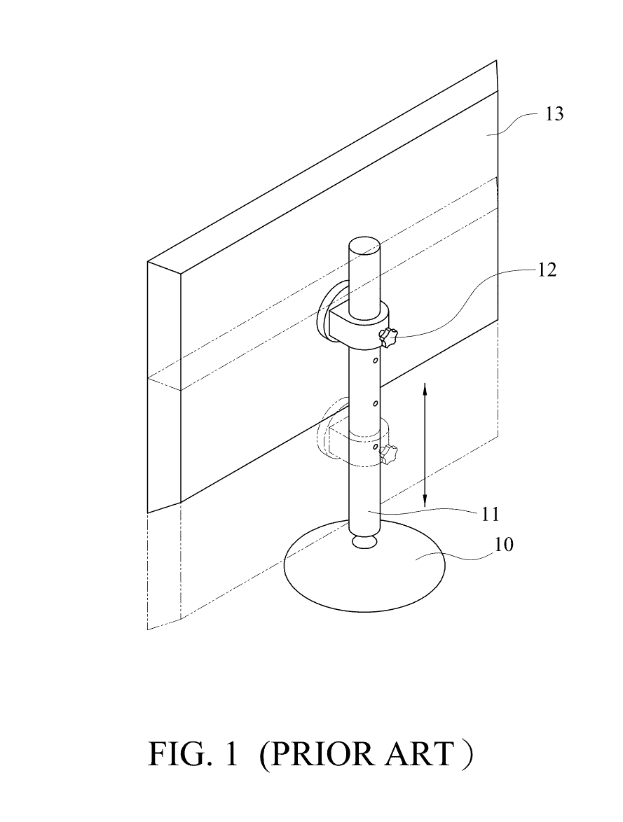

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification. Note that the structures, proportions, sizes depicted in the accompanying figures, as well as the expressions “upper” “end” “abutting” “lifting” “parallel” “sliding” “smoothing” “first” and “second” described merely serve to illustrate the disclosure of the specification to allow for comprehensive reading without a limitation to the implementation or applications of the present invention, and does not constitute any substantial technical meaning.

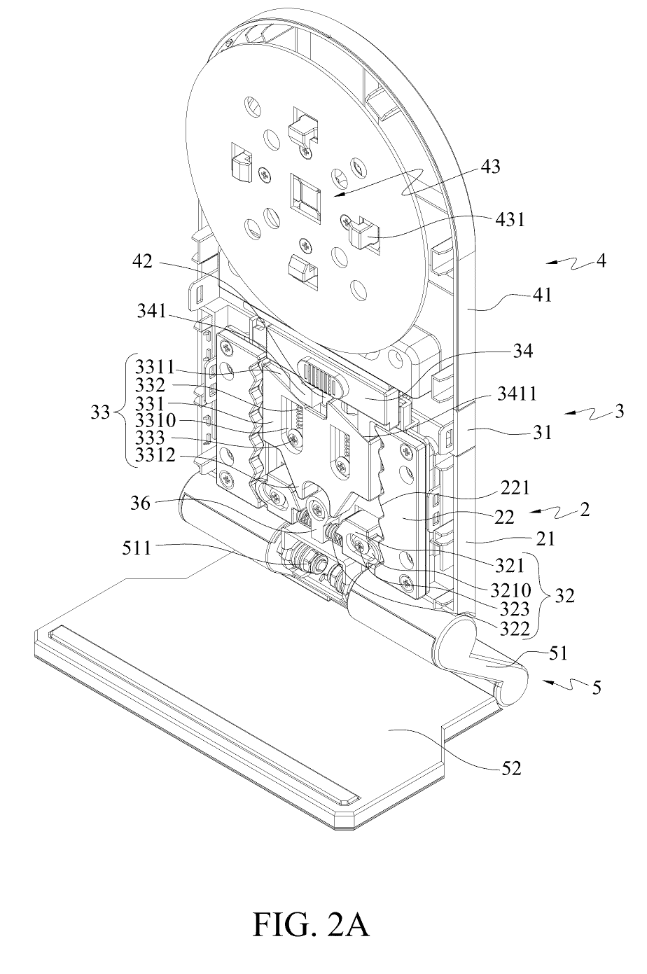

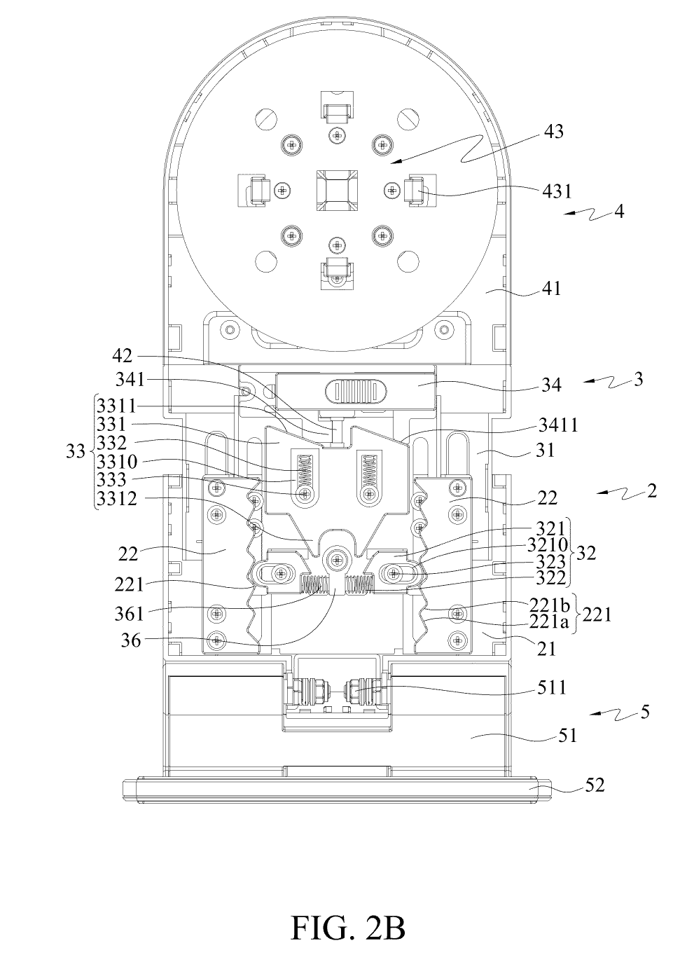

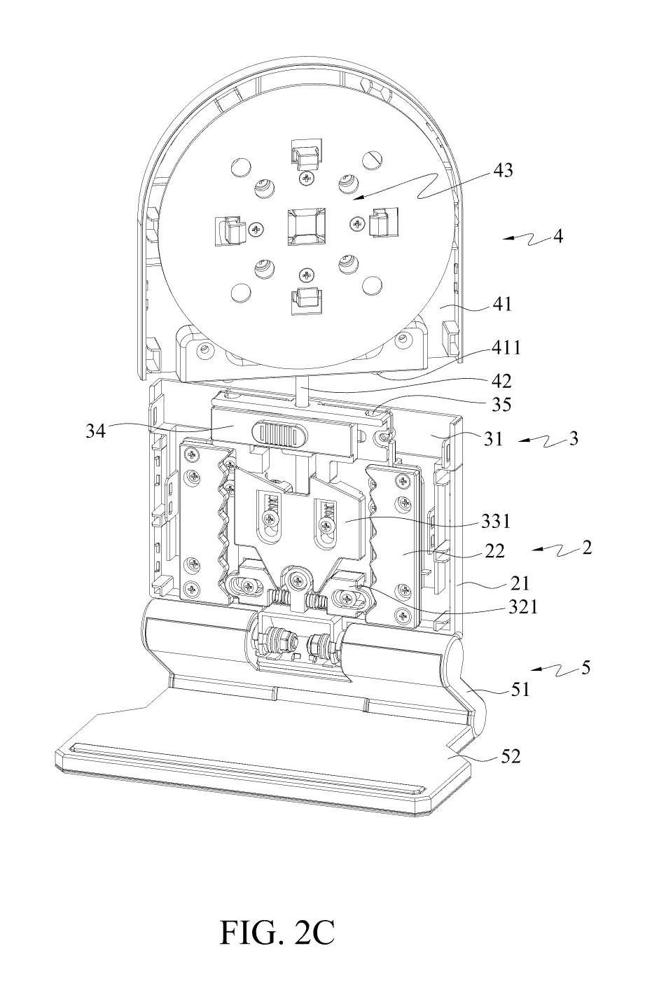

FIGS. 2A to 2C are schematic views showing the lift device, in which FIGS. 2A and 2C are 3D views of the lift device and FIG. 2B is a front view of the lift device. FIGS. 2A and 2B illustrate the lifting mode of the lift device and FIG. 2C depicts the rotating mode of the lift device according to the present invention. As illustrated in the Figures, the lift device of the present invention includes a main body unit 2, a lifting unit 3, a rotating unit 4 and a base 5, wherein the lifting unit 3 includes two abutting members 32 and the rotating unit 4 has a connecting rod 42.

The lift device of the invention mainly functions in two modes, namely, a lifting mode and a rotating mode (or non-lifting mode). In the lifting mode shown in FIGS. 2A and 2B, the abutting members 32 are movable, the lifting unit 3 and the rotating unit 4 can be lifted with respect to the main body unit 2, and the rotating unit 4 cannot rotate with respect to the lifting unit 3.

In the rotating mode shown in FIG. 2C, the abutting members 32 are not movable, the rotating unit 4 and the connecting rod 42 are rotatable with respect to the lifting unit 3, and the lifting unit 3 and the rotating unit 4 cannot be lifted with respect to the main body unit 2.

The main body unit 2 includes a first board 21 and two racks 22. The two racks 22 are separately and parallelly configured on the first board 21 in a first direction, wherein one of the two racks has a first side and the other of the two racks has a second side opposing to the first side, and wherein a plurality of protruding portions 221 are disposed on each of the first side and the second side of the two racks 22.

The lifting unit 3 includes a lifting board 31, two abutting members 32, a blocking member 33 and a lifting switch member 34. The lifting board 31 is in a T shape and disposed on the first board 21 and parallel to the first board 21, and is slidable with respect to the first board 21 at the first direction. The two abutting members 32 are disposed on the lifting board 31 between the two racks 22, and include two abutting blocks 321 and two first elastic members 322. The abutting blocks 321 can slide with respect to the lifting board 31 in a second direction perpendicular to the first direction. In other preferred embodiments, the abutting blocks 321 can slide with respect to the lifting board 31 in a direction, which is not perpendicular to (intersecting) the first direction. The two first elastic members 322 are disposed on the lifting board 31 to abut against the other ends of the abutting blocks 321. Due to elasticity, the first elastic members 322 enable one end of the two abutting blocks 321 to abut against the protruding portions 221 of the racks 22 under a normal condition.

Further, a supporting component 36 is disposed on the lifting board 31 and has two protruding columns 361 respectively extending toward different sides and being substantially perpendicular to the first direction. The first elastic members 322 respectively sleeve on the protruding columns 361 and abut against the supporting component 36. Each abutting block 321 has a first slot 3210 substantially perpendicular to the first direction, and a screw 323 is fastened in the first slot 3210, such that the abutting blocks 321 can slide in the second direction. In this preferred embodiment, the first elastic members 322 are, but not limited to, two compressed springs.

Specifically, each protruding portion 221 includes an ascending surface 221a connected to a descending surface 221b, and the descending surface 221b is more inclined than the ascending surface 221a with respect to the first direction.

In the lifting device of this preferred embodiment, the blocking member 33 is disposed on the lifting board 31 and has two stopping blocks 331 and two second elastic members 332. The stopping blocks 331 can slide with respect to the lifting board 31 in the first direction. Two second slots 3310 extending and being substantially parallel to the first direction are formed the two stopping blocks 331, and two screws 333 are fastened in the second slots 3310, thereby enabling the stopping blocks 331 to slide in the first direction. In this preferred embodiment, the two second elastic members 322 are, but not limited to, compressed springs, respectively accommodated in the slots 3310. One end of each second elastic member 332 is disposed on the lifting board 31 and abuts against the screw 333 respectively, and the other end of each second elastic member 332 abuts against the stopping block 331. Therefore, under the normal condition, the second elastic members 332 enable the stopping blocks 331 to depart from the abutting members 32.

Moreover, the stopping blocks 331 respectively have two first slanting surfaces 3311 at the upper end, and two stopping portions 3312 at the lower end. In a lifting mode shown in FIG. 2B, the stopping blocks 331 depart from the abutting members 32, and the two stopping portions 3312 do not abut against the inner sides of the two abutting blocks 321. In a rotating mode shown in FIG. 2C, the stopping blocks 331 insert between the abutting blocks 32 and supporting component 36, and the two stopping portions 3312 respectively abut against the inner sides of the abutting blocks 321, thereby preventing the abutting blocks 321 from sliding in the first direction and departing from the racks 22. In other words, the stopping blocks 331 can slide upward and downward to switch between the lifting mode and the rotating mode as required.

A lifting switch member 34 is disposed on the lifting board 31 and slidable in the second direction with respect to the lifting board. A bottom end of the lifting switch member 34 has two protrusions 341 with a second slanting surface 3411 corresponding to first slanting surface 3311 of the stopping block 331. The two protrusions 341 are configured to propel the stopping block 331 to approach and abut against the two abutting members 321. In the lifting mode of the lift device shown in FIG. 2B, the lifting switch member 34 is propelled to the rightmost side; and in the rotating mode of the lift device shown in FIG. 2C, the lifting switch member 34 is propelled to the leftmost side. In other words, the lifting switch member 34 can be propelled to the right or left side, so as to switch between the lifting mode and the rotating mode.

The rotating unit 4 includes a support member 41, a connecting rod 42 and a securing assembly 43 having four coupling portions 431, wherein the support member 41 is connected to the lifting board 31 by means of the connecting rod 42. The rotating unit 4 and the connecting rod 42 can rotate with respect to the lifting unit 3. The connecting rod 42 has a middle section, a small section and a large section disposed orderly from the top to the bottom thereof, wherein the small section, the middle section and the large section respectively have a small, medium and large diameters.

The lift device operates in the lifting mode and the rotating mode as described below.

In the lifting mode shown in FIGS. 2A and 2B, the lifting switch member 34 is pushed to the rightmost side. At this time, the second elastic members 332 push the stopping blocks 331 upward for enabling the first slanting surfaces 3311 to push the lifting switch member 34 to the rightmost side. Meanwhile, the protrusions 341 of the lifting switch member 34 abut against the small section of the connecting rod 42, and the top and bottom of the protrusions 341 are respectively blocked by the middle section and the large section so as to buckle up the connecting rod 42. Thus, the rotating unit 4 is disabled from being lifted upward and downward with respect to the lifting unit 3. Furthermore, the two protrusions 411 formed on a bottom end of the rotating unit 4 are coupled to the two recessed portions 35 that are formed on a top end of the lifting unit 3. Thus, the lifting unit 3 and the rotating unit 4 are connected together, and the rotating unit 4 is disabled from rotating with respect to the lifting unit 3.

On the other hand, referring to FIG. 2B, the protrusions 341 are disposed in a right sided position at a right end of the first slanting surfaces 3311, such that the stopping blocks 331 are pushed upward by the second elastic members 332 and depart from the abutting members 32. The stopping portions 3312 are kept from abutting against the inner sides of the two abutting blocks 321. Now, the stopping blocks 331 can no longer limit the abutting blocks 321. Thus, the abutting blocks 321 are able to slide along the racks 22 if operated. Subsequently, the support members 41 and the lifting board 31 can slide upward or downward with respect to the first board 21.

That is, since the abutting blocks 321 abut against the protruding portions 221 of the racks 22 by the first elastic members 322, the abutting blocks 321 can move along with the protruding portions 221 of the racks 22 when an external force is applied on the lifting board 31 to lift the lifting board 31 upward or downward to deform the first elastic members 322. When the abutting blocks 321 traverse across at least one of the protruding portions 221 and the external force is released, the abutting blocks 321 and the lifting board 31 remain at the required height. The friction and vertical dividing force generated by the first elastic members 322 withhold the weight of the lifting unit 3 and the rotating unit 4 to remain the abutting blocks 321 at a recess between the protruding portions 221 at a certain height.

Further, the descending surfaces 221b is more inclined than the ascending surfaces 221a of the lift device with respect to the first direction. Therefore, it is relatively easy to lift up the support members 41 and the lifting board 31. Also, the weight of the support members and the lifting board 31 are easily supported by the design.

Moreover, in the rotating mode shown in FIG. 2C, the lifting switch 34 is pushed to the leftmost side by an external force, and the protrusions 341 slide along the right end of the first slanting surfaces 3311 to the left end to push the stopping blocks 331 downward completely by the coordination of second slating surfaces 3411 and first slanting surfaces 3311. The stopping blocks 331 are enabled to draw near the abutting members 32. The two blocking portions 3312 respectively abut against the inner sides of the two abutting blocks 321 to block and immobilize the abutting blocks 321 so as to keep them from being lifted up and down. At this time, the protrusions 341 of the lifting switch 34 do not buckle up the connecting rod 42, and the rotating unit 4 is pulled upward to be free from being restricted by the recessed portion 35. In other words, the rotating unit 4 detaches from the lifting unit 3 and can rotate with respect to the lifting unit 3 along with the connecting rod 42. The connecting rod 42 has a large section formed thereon which cannot pass through a hole disposed in the middle section of the lifting unit 3, for ensuring that the connecting rod 42 would not completely detach from the lifting unit 3. The rotating unit 4 can be connected downward to the lifting unit 3 upon rotating to a certain angle, such as 180 degrees.

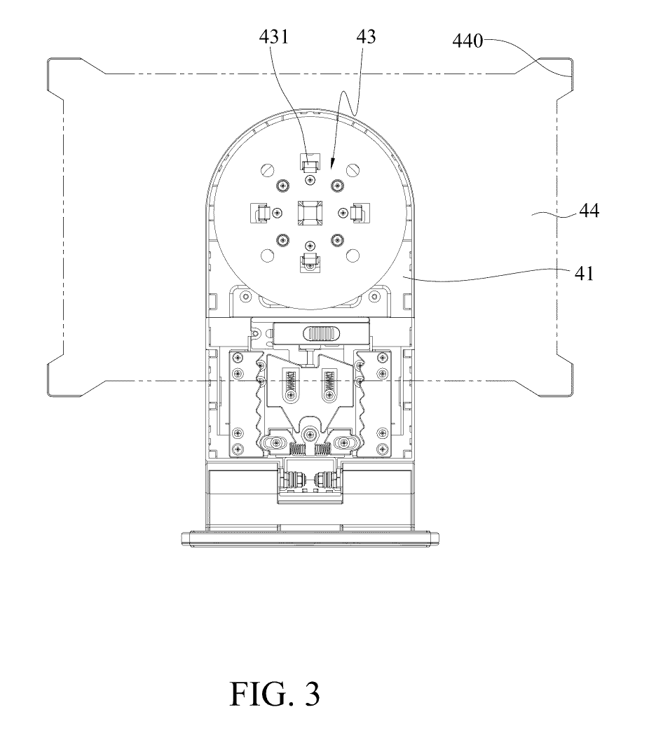

Referring FIGS. 2A to 2C and FIG. 3, the rotating unit 4 further includes a display rack 44 and a securing assembly 43 for efficiently assembling or dismantling the display rack 44 from the securing assembly 43, and the display rack 44 has an accommodating recess 440 for accommodating a display unit (of a tablet computer, liquid crystal screen or a Smart phone).

The base 5 of the lifting device of the invention includes a second board 51 and a third board 52. A first side of the second board 51 is pivotally connected to a bottom side of the first board 21 by two hinges 511. One side the third board 52 is pivotally connected to a second side of the second board 51 by two hinges (no shown), wherein the second side of second board 51 is opposing to which the first board 21 is pivotally connected to, thereby forming a display support base.

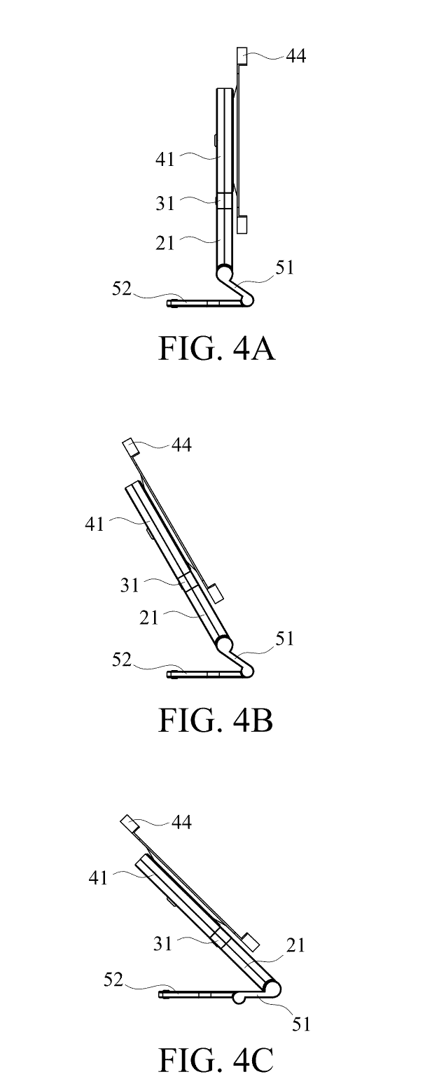

As shown in FIGS. 4A to 4C, the advantage of using the second and third boards 51, 52 is that, by altering the angle between the combined first and second boards 21, 51 and the angle between the combined second and third boards 51, 52, the general gravity center of all components always projects onto the third board 52. Thus, the lift device is stably disposed at different angles on a common plane surface, such as a desk, and also the user is allowed to adjust the display unit to an optimal and desired viewing angle and height. Note that the foregoing described first direction may alter depending on the pivotal angles of the base 5 and not always be perpendicular to the desk on which it is placed upon, but the base 5 will still be parallel to the first board 21.

Accordingly, the lift device of the invention is not only applicable for supporting tablet computers, LCD screens or Smart phones and easily manipulated by means of the constituents of racks and elastic members, but also allows for adjustments of rotating and lifting angles with greater applicability and practicality.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A lift device, comprising
a main body unit comprising:
a first board; and
two racks separately and parallelly configured on the first board in a first direction, wherein one of the two racks has a first side and the other of the two racks has a second side opposing to the first side, and wherein a plurality of protruding portions are disposed on each of the first side and the second side of the two racks; and
a lifting unit comprising:
a lifting board disposed on and parallel to the first board, and being slidable with respect to the first board in the first direction; and
two abutting members disposed on the lifting board between the two blocks and each having an abutting block and a first elastic member, wherein the abutting block is slidable with respect to the lifting board in a second direction perpendicular to the first direction, and the first elastic member is disposed on the lifting board to abut against one end of the abutting block for enabling the other end of the abutting block to abut against the protruding portions under a normal condition.

2. The lift device of claim 1, wherein the lifting unit further comprises a blocking member having a stopping block disposed on the lifting board, and being slidably approaching or departing from the two abutting members with respect to the lifting board, thereby switching between a lifting mode and a non-lifting mode, wherein in the lifting mode, the stopping block departs from the abutting blocks, and in the non-lifting mode, the stopping block approaches and abuts against the abutting blocks to prevent the abutting blocks from sliding away the racks.

3. The lift device of claim 2, wherein the lifting unit further comprises a lifting switch member disposed on the lifting board and being slidable with respect to the lifting board in the second direction or a direction intersecting the first direction so as to switch between the lifting mode and the non-lifting mode, and the lifting switch member propels the stopping block to approach and abut against the two abutting members.

4. The lift device of claim 3, wherein a top end of the stopping block has two first slanting surfaces, a bottom end of the lifting switch member has two protrusions, a bottom end of each of the protrusions has a second slanting surface corresponding to first slanting surfaces of the stopping block, and the two protrusions are configured to propel the stopping block to approach and abut against the two abutting members, wherein in the lifting mode of the lift device, the stopping block is not propelled by the two protrusions, and in the non-lifting mode of the lift device, the two protrusions propel the stopping block to approach and abut against the two abutting members.

5. The lift device of claim 3, wherein the blocking member further comprises a second elastic member, one end of the second elastic member is disposed on the lifting board and the other end of the second elastic member abuts against the stopping block, and wherein the second elastic member keeps the stopping block away from the abutting blocks, such that the lift device is maintained in the lifting mode when there is no external force applied on the abutting blocks.

6. The lift device of claim 5, wherein the first and second elastic members are compression springs.

7. The lift device of claim 1, further comprising a rotating unit, which comprises a support member and a connecting rod, wherein the support member is connected to the lifting board by means of the connecting rod, and rotates with respect to the lifting unit along with the connecting rod in the non-lifting mode.

8. The lift device of claim 7, wherein the connecting rod has a middle section, a small section and a large section formed orderly from the top to the bottom thereof, and in the lifting mode, one of the protrusions of the lifting switch member abuts against the small section of the connecting rod but is restricted by the middle section and the large section so as to buckle up the connecting rod.

9. The lift device of claim 7, wherein the rotating unit has two proportions configured on an lower end thereof for being coupled to two recessed portions formed on an upper end of the lifting unit in the lifting mode.

10. The lift device of claim 8, wherein one of the protrusions of the lifting switch member do not abut against the small section of the connecting rod and thus does not restrict the connecting rod in the non-lifting mode.

11. The lift device of claim 7, wherein the rotating unit further includes a securing assembly unit disposed on the support member and a display rack, in which the display rack is connected to the securing assembly and has an accommodating recess.

12. The lift device of claim 1, further comprising a base having a second board and a third board, one side of the second board being pivotally connected to a bottom side of the first board, and one side of the third board being pivotally connected to a side opposing to the bottom side of the first board connected to the second board.

13. The lift device of claim 1, wherein each of the protruding portions of the two racks includes an ascending surface and a descending surface connected to each other, in which the descending surface is more inclined than the ascending surface with respect to the first direction.
